(19) United States
(12) Patent Application Publication
(10) Pub. No.: US 2011/0211177 A1
(43) Pub. Date: Sep. 1, 2011

(54) POWER SUPPLY DEVICE WITH PROJECTING FUNCTION

(75) Inventors: Ming-Tsung Lee, Taoyuan Hsien (TW); Chen-Yu Yu, Taoyuan Hsien (TW); Mao-Hsien Lan, Taoyuan Hsien (TW); Shih-Kai Chien, Taoyuan Hsien (TW); Chin-Tsai Chiang, Taoyuan Hsien (TW)

(73) Assignee: DELTA ELECTRONICS, INC., Taoyuan Hsien (TW)

(21) Appl. No.: 13/035,684

(22) Filed: Feb. 25, 2011

(30) Foreign Application Priority Data
Mar. 1, 2010 (TW) 099105861

(51) Int. Cl. G03B 21/14; G03B 21/00

(52) U.S. Cl. 353/119; 353/122

(57) ABSTRACT

A power supply device includes a mini projecting module, a power converting module and a signal transmission element. The power converting module includes a power input part, a power converting circuit and a power output part. The power converting circuit is used for converting the input voltage into a first output voltage and a second output voltage. The first output voltage and the second output voltage are respectively transmitted to an electronic device and the mini projecting module. The first output voltage is transmitted to the electronic device through the power output part. The signal transmission element is used for connecting the electronic device or an image signal source with the mini projecting module so that an image signal provided by the electronic device or the image signal source is transmitted to the mini projecting module through the signal transmission element.

### FIELD OF THE INVENTION

The present invention relates to a power supply device, and more particularly to a power supply device with a projecting function.

### BACKGROUND OF THE INVENTION

With rapid development of digitalized techniques, projectors become essential electronic appliances in many applications. For example, projectors can be used for making presentations, holding meetings or giving lectures in classrooms, boardrooms, conference rooms or home theaters. Generally, the projector is used for enlarging an image provided by an image source and projecting the enlarged image on a projection screen or a wall.

FIG. 1 is a schematic view illustrating the architecture of a projecting system according to the prior art. As shown in FIG. 1, the projecting system 1 comprises a portable computer 10, a projector 11, a projection screen 12, a signal transmission line 13, a power supply 14 and a power cable 15. The power supply 14 is interconnected between a power socket (not shown) and the portable computer 10 for providing electricity to the portable computer 10. The power cable 15 is interconnected between a power socket (not shown) and the projector 11 for transmitting electricity to the projector 11. The portable computer 10 is connected with the projector 11 through the signal transmission line 13. The image signal provided by the portable computer 10 could be transmitted to the projector 11 through the signal transmission line 13. The image signal is processed by the projector 11 and then projected on the projection screen 12.

Recently, the general trends in designing electronic devices are toward small size, light weightiness and easy portability. As a consequence, a mini projector is developed. In addition, the novel portable communication device or notebook computer has the functions of the mini projector. The lens of the mini projector is embedded in the portable communication device or notebook computer. The image signal provided by the portable communication device or notebook computer is projected onto a projection screen through the mini projector.

During operations of the conventional projecting system, the projector is connected with a portable computer through a signal transmission line, then the projector is connected to a power socket through a power cable to receive electricity from the utility power source, and finally the image signal is transmitted from the portable computer to the projector to be enlarged and projected onto a projection screen or a wall. In other words, the essential components of the conventional projecting system comprise a large-sized or mini projector, a signal transmission line and a power cable. In addition, two power sockets are necessary for providing electricity to the portable computer and the projector. Since the architecture of the conventional projecting system is relatively complicated and difficult to assemble, the conventional projecting system is costly. In addition, too many components increase the possibility of losing the components. On the other hand, if no utility power source is available in the working place, the conventional projecting system fails to operate.

Recently, a notebook computer having a projecting lens is disclosed. Although this notebook computer is easily carried, there are still some drawbacks. For example, the notebook computer is still bulky in volume and heavy in weight. In addition, it is difficult to adjust the projecting angle. Generally, during the projecting angle is adjusted, the position of the whole notebook computer needs to be changed. Under this circumstance, the possibility of colliding or dropping the notebook computer is increased, and thus the notebook computer is readily damaged. Moreover, for complying with the position of the notebook computer, the scope of the projecting angle is restricted.

Therefore, there is a need of providing a power supply device with a projecting function so as to obviate the drawbacks encountered in the prior art.

### SUMMARY OF THE INVENTION

The present invention provides a power supply device having a projecting function. The mini projecting module is installed within the power converting module. The image signal provided by an image signal source is processed by the mini projecting module and then projected onto a projection screen or a wall. The power supply device of the present invention is advantageous because it has small size, light weightiness and easy portability. In addition, the projecting lens is adjustable to result in a desired projecting angle.

Moreover, the power converting module can provide electricity to the mini projecting module and an external electronic device, and thus the applications of the power supply device of the present invention are expanded.

Moreover, the power converting module and the mini projecting module may be combined together or detached from each other according to the practical requirements. In this situation, the mini projecting module further comprises a chargeable energy storage unit. Once the mini projecting module is detached from the power converting module, the chargeable energy storage unit provides electricity for powering the mini projecting module. Whereas, once the mini projecting module is connected with the power converting module, the electricity is transmitted from the power converting module to the mini projecting module while charging the chargeable energy storage unit.

In accordance with an aspect of the present invention, there is provided a power supply device with a projecting function. The power supply device includes a mini projecting module, a power converting module and a signal transmission element. The mini projecting module includes a projecting lens for projecting an image. The power converting module includes a power input part, a power converting circuit and a power output part. The power input part is used for receiving an input voltage. The power converting circuit is electrically connected with the power input part for converting the input voltage into a first output voltage and a second output voltage. The first output voltage and the second output voltage are respectively transmitted to an electronic device and the mini projecting module. The power output part is electrically connected with the power converting circuit. The first output voltage is transmitted from the power converting circuit to the electronic device through the power output part. The signal transmission element is used for connecting the electronic device or an image signal source with the mini projecting module so that an image signal provided by the electronic device or the image signal source is transmitted to the mini projecting module through the signal transmission element.

In accordance with another aspect of the present invention, there is provided a power supply device with a projecting function. The power supply device includes a mini projecting module, a power converting module and a signal transmission element. The mini projecting module includes a projecting lens for projecting an image. The power converting module includes a power input part and a power converting circuit. The power input part is used for receiving an input voltage. The power converting circuit is electrically connected with the power input part for converting the input voltage. The signal transmission element is used for connecting an image signal source with the mini projecting module so that an image signal provided by the image signal source is transmitted to the mini projecting module through the signal transmission element. The power converting module provides electricity required for powering the mini projecting module and an external electronic device.

In accordance with a further aspect of the present invention, there is provided a projecting system. The projecting system includes an electronic device and a power supply device with a projecting function. The power supply device includes a mini projecting module, a power converting module and a signal transmission element. The mini projecting module includes a projecting lens for projecting an image. The power converting module includes a power input part for receiving an input voltage, and a power converting circuit electrically connected with the power input part for converting the input voltage. The signal transmission element is used for connecting the electronic device or an image signal source with the mini projecting module so that an image signal provided by the electronic device or the image signal source is transmitted to the mini projecting module through the signal transmission element. The power converting module provides electricity required for powering the mini projecting module and the electronic device.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the architecture of a projecting system according to the prior art;

FIG. 2 is a schematic view illustrating a power supply device with a projecting function according to an embodiment of the present invention;

FIG. 3 is a schematic view illustrating a projecting system according to an embodiment of the present invention;

FIG. 4A is a schematic functional block diagram illustrating an exemplary projecting system of FIG. 3;

FIG. 4B is a schematic functional block diagram illustrating another exemplary projecting system of FIG. 3;

FIG. 4C is a schematic functional block diagram illustrating another exemplary projecting system of FIG. 3;

FIG. 5 is a schematic view illustrating a power supply device with a projecting function according to another embodiment of the present invention;

FIGS. 6A and 6B are schematic views illustrating a projecting system according to another embodiment of the present invention;

FIG. 7A is a schematic functional block diagram illustrating an exemplary projecting system of FIG. 5;

FIG. 7B is a schematic functional block diagram illustrating another exemplary projecting system of FIG. 5; and

FIG. 8 is a schematic view illustrating a power supply device with a projecting function according to a further embodiment of the present invention.

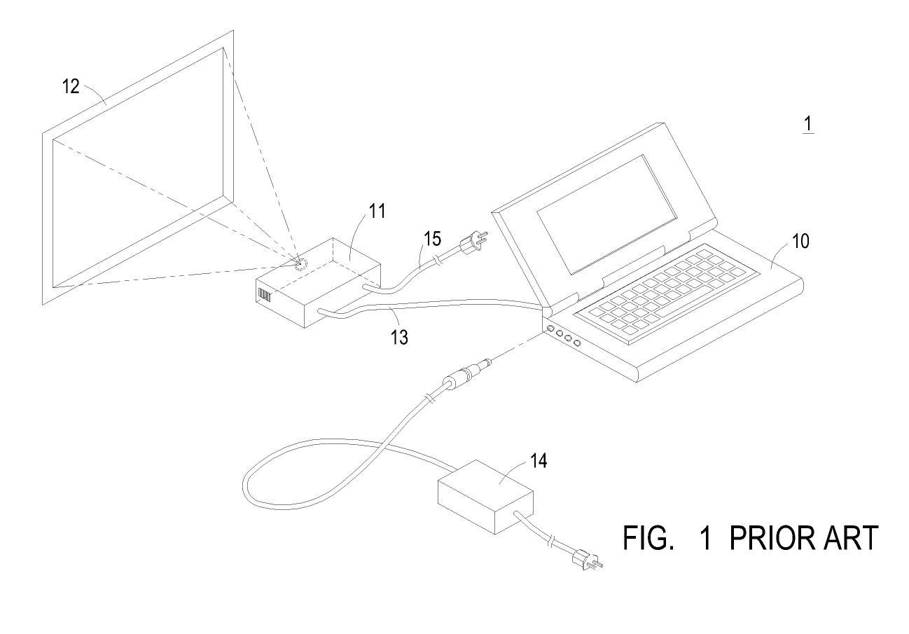

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

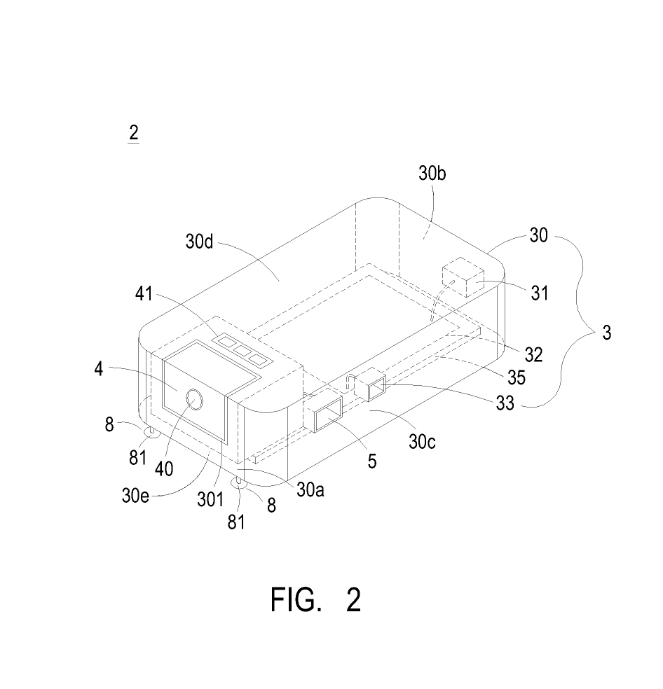

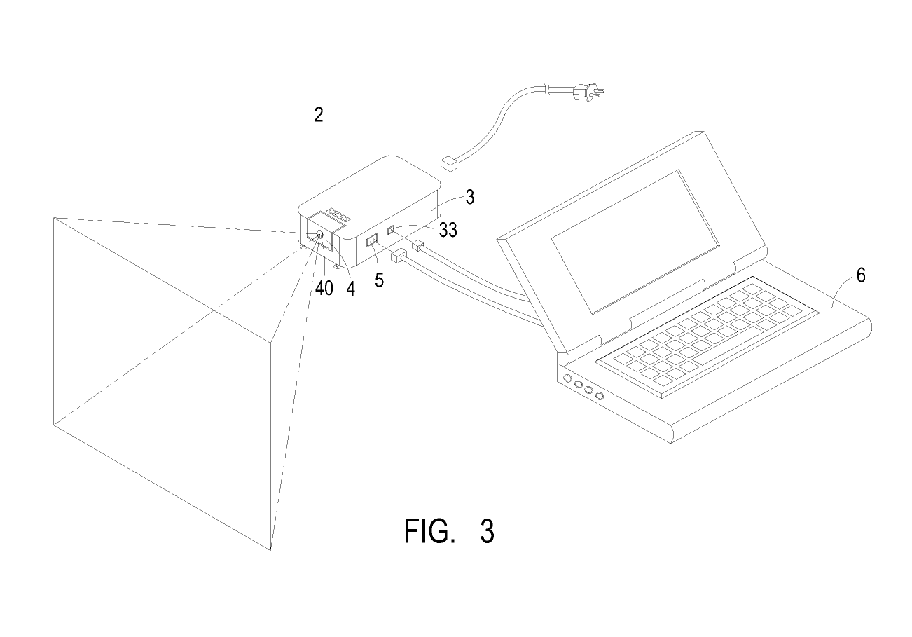

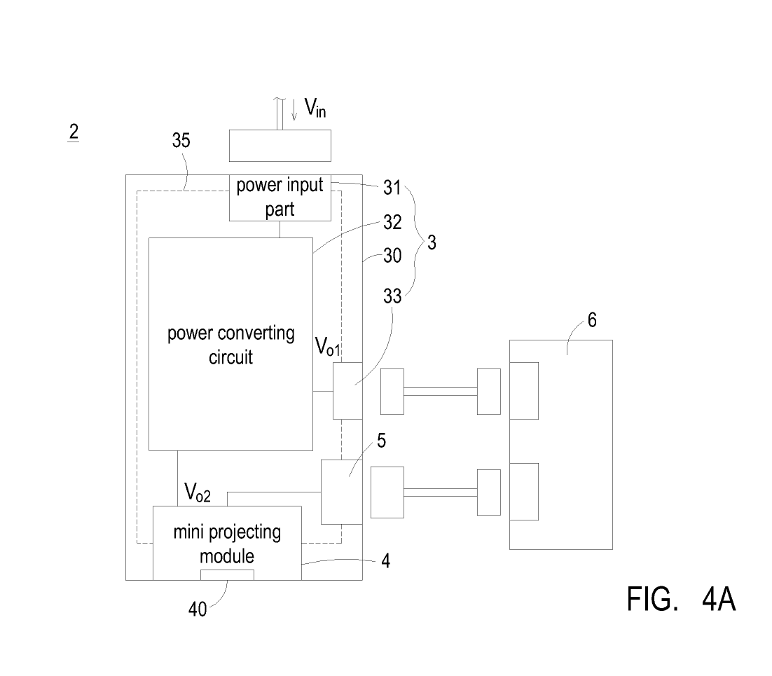

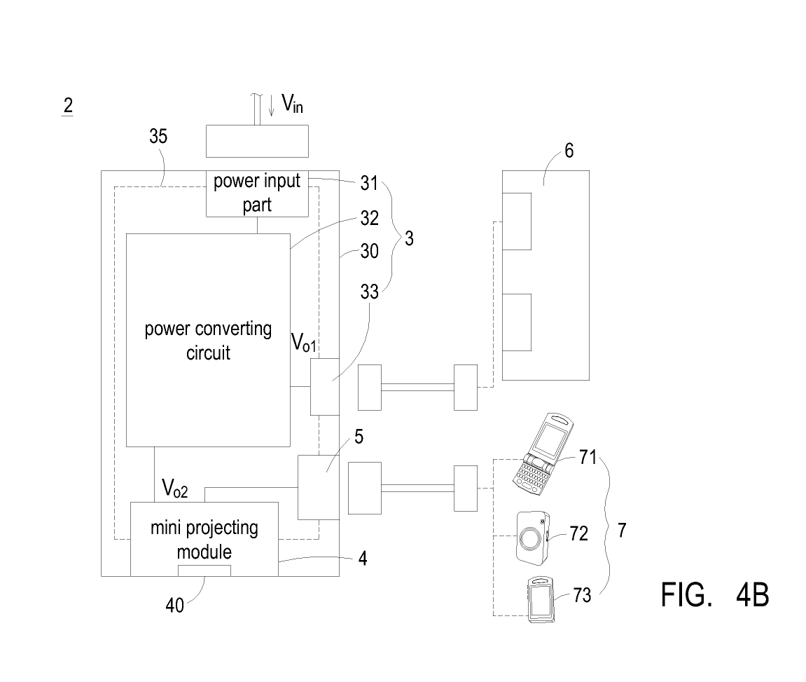

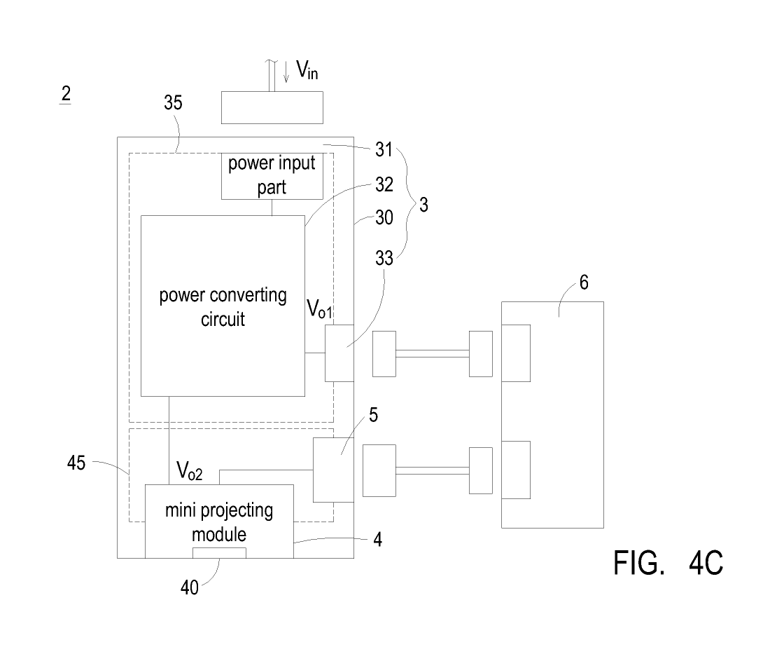

FIG. 2 is a schematic view illustrating a power supply device with a projecting function according to an embodiment of the present invention. FIG. 3 is a schematic view illustrating a projecting system according to an embodiment of the present invention. FIG. 4A is a schematic functional block diagram illustrating an exemplary projecting system of FIG. 3. Please refer to FIGS. 2, 3 and 4A. The power supply device 2 comprises a power converting module 3, a mini projecting module 4 and a signal transmission element 5. The power converting module 3 comprises a casing 30, a power input part 31, a power converting circuit 32 and a power output part 33. The power converting circuit 32 is mounted on a circuit carrier 35 (e.g. a printed circuit board). The mini projecting module 4 is integrated into and built in the internal portion of the casing 30 of the power converting module 3. The mini projecting module 4 comprises a projecting lens 40. The projecting lens 40 is exposed outside the casing 30. In addition, the mini projecting module 4 is directly or indirectly connected with a portable electronic device 6 (e.g. an image signal source) through the signal transmission element 5 according to a wired or wireless transmission technology. An example of the portable electronic device 6 is a portable computer. The image signal provided by the portable electronic device 6 is processed by the mini projecting module 4 and then projected onto a projection screen or a wall (not shown).

The power input part 31 of the power converting module 3 is connected with an external power source (e.g. a utility power source) for receiving an input voltage Vin. In addition, the power input part 31 is electrically connected with the power converting circuit 32. By the power converting circuit 32, the input voltage Vin is converted into a first output voltage Vo1 and a second output voltage Vo2. The first output voltage Vo1 is transmitted to the portable electronic device 6 through the power output part 33 (e.g. an electric connector, a power cable or a combination thereof). The power converting circuit 32 is also electrically connected with the mini projecting module 4. The second output voltage Vo2 is transmitted to the mini projecting module 4. In other words, the first output voltage Vo1 and the second output voltage Vo2 are respectively transmitted to the electronic device 6 and the mini projecting module 4. An example of the portable electronic device 6 includes a portable computer. The power converting module 3 is a power converter or a power adapter.

As shown in FIG. 4A, the portable electronic device 6 is a portable computer. In this embodiment, the power converting module 3 can provides electricity required for powering the portable computer 6. In addition, the image signal provided by the portable computer 6 is transmitted to the mini projecting module 4 through the signal transmission element 5. In some embodiments, another electronic device 7 provides the image signal to the mini projecting module 4. As shown in FIG. 4B, an example of the electronic device 7 includes but is not limited to a portable communication device 71, a digital camera 72, a multimedia player (e.g. MP4 player) 73.

In this embodiment, the mini projecting module 4 is integrated into and built in the internal portion of the casing 30 of the power converting module 3. The projecting lens 40 is disposed within a receptacle 301 in a first surface 30a of the casing 30. In addition, the projecting lens 40 is partially exposed to the first surface 30a of the casing 30. The projecting lens 40 could be rotated in any direction by the user in order to adjust a desired projecting angle. In addition to the projecting lens 40, the mini projecting module 4 further comprises a light source (not shown) and an image-processing unit (not shown). An example of the light source includes but is not limited to a LED light-emitting element or a laser light-emitting element. Moreover, an operating interface 41 is disposed on a fourth surface 30d of the casing 30. Via the operating interface 41, the dimension, brightness, focal length, angle or resolution of the image signal shown on the projection screen could be adjusted. Alternatively, the dimension, brightness, focal length, angle or resolution of the image signal shown on the projection screen could be adjusted according to an IR remote control technology. In some embodiments, the light source and the image processing unit could be integrated into the circuit carrier 35. FIG. 4C is a schematic functional block diagram illustrating another exemplary projecting system of FIG. 3. As shown in FIG. 4C, the mini projecting module 4 further comprises a circuit board 45. The circuit board 45 is electrically connected to the circuit carrier 35. The light source and the image processing unit could be integrated into the circuit board 45.

The power input part 31 of the power converting module 3 is disposed in the second surface 30b of the casing 30. The power input part 31 is electrically connected between an external power source and the power converting circuit 32 for receiving the input voltage Vin from the external power source, and transmitting the input voltage Vin to the power converting circuit 32. The power input part 31 is for example an electric connector, a power cable or a combination thereof. The power converting circuit 32 is mounted on the circuit carrier 35. In this embodiment, the power converting circuit 32 is an AC/DC converter for converting the input voltage Vin (e.g. an AC voltage) into the first output voltage Vo1 (e.g. a DC voltage) and the second output voltage Vo2 (e.g. a DC voltage). The power output part 33 is disposed in a third surface 30c of the casing 30, and electrically connected to the power converting circuit 32. As such, the first output voltage Vo1 could be transmitted to the portable electronic device 6 through the power output part 33. The power output part 33 is for example an electric connector, a power cable or a combination thereof. The second output voltage Vo2 is transmitted from the power converting circuit 32 to the mini projecting module 4 through a wire. The magnitudes of the first output voltage Vo1 and the second output voltage Vo2 are identical or different. The signal transmission element 5 is disposed in the third surface 30c of the casing 30 for directly or indirectly connecting the mini projecting module 4 with the portable electronic device 6. As such, the image signal provided by the portable electronic device 6 is processed by the mini projecting module 4 and then projected onto the projection screen. An example of the signal transmission element 5 includes but is not limited to an electric connector, a signal connecting cable or a combination thereof. The signal connecting cable is an analog signal connecting cable, a digital signal connecting cable, an optical cable (e.g. an optical fiber cable), or the like. In some embodiments, the signal transmission element 5 is a wireless transmission module (e.g. a Bluetooth module).

In some embodiments, the power supply device 2 further comprises plural height-adjusting elements 8 (see FIG. 2). The height-adjusting elements 8 are disposed on the bottom surface 30e of the casing 30 and arranged in the vicinity of the corners of the bottom surface 30e. By means of the height-adjusting elements 8, the height of the power supply device 2 is changed, and thus the projecting zone is vertically adjusted according to the practical requirements. An example of the height-adjusting element 8 includes but is not limited to a storable stand, a foldable stand or a rotatable element. In some embodiments, the height-adjusting element 8 has a cushion or a sucker 81 for facilitating fixing the power supply device 2 on a working plane and preventing from abrading the working plane.

In some embodiments, a power cable and a signal connecting cable may be sheathed by a covering body (not shown) so as to form an integrated transmission cable. Alternatively, the power cable and the signal connecting cable are separated from each other but combined together via a fixing element. In some embodiments, the power output part 33 and the signal transmission element 5 are integrated into an electric connector, or separated from each other.

In some embodiments, the power output part 33 and the signal transmission element 5 are conductive pads. As such, the power supply device 2 could be directly attached on the main body of the portable electronic device 6 without the power cable and the signal connecting cable. That is, the electricity transmission and the image signal transmission between the power supply device 2 and the portable electronic device 6 are achievable through the conductive pads.

In some embodiments, the projecting lens 40 of the mini projecting module 4 is implemented by an optical transmission line (not shown). The optical transmission line could be extended to a far site and provide multi-directional and multi-angular projecting effects. In this situation, the image processing unit could be optionally installed within the portable electronic device 6, and the image signal is transmitted to the power supply device 2 through an optical transmission line and projected by the projecting lens 40.

In a case that the input voltage Vin fails to be transmitted to the power supply device 2 through the power input part 31, the electricity stored in the battery of the portable electronic device 6 could be reversely transmitted to the power supply device 2 through the power output part 33, and then directly transmitted to the mini projecting module 4 or indirectly transmitted to the mini projecting module 4 through the power converting circuit 32.

In some embodiments, the power converting circuit 32 comprises a first-stage power converting unit and a second-stage power converting unit (not shown). The first-stage power converting unit is an AC/DC converter, and the second-stage power converting unit is a DC/DC converter. The input voltage Vin is converted into the first output voltage Vo1 by the first-stage power converting unit; and the input voltage Vin is converted into the second output voltage Vo2 by the first-stage power converting unit and the second-stage power converting unit. Alternatively, the input voltage Vin is converted into the second output voltage Vo2 by the first-stage power converting unit; and the input voltage Vin is converted into the first output voltage Vo1 by the first-stage power converting unit and the second-stage power converting unit.

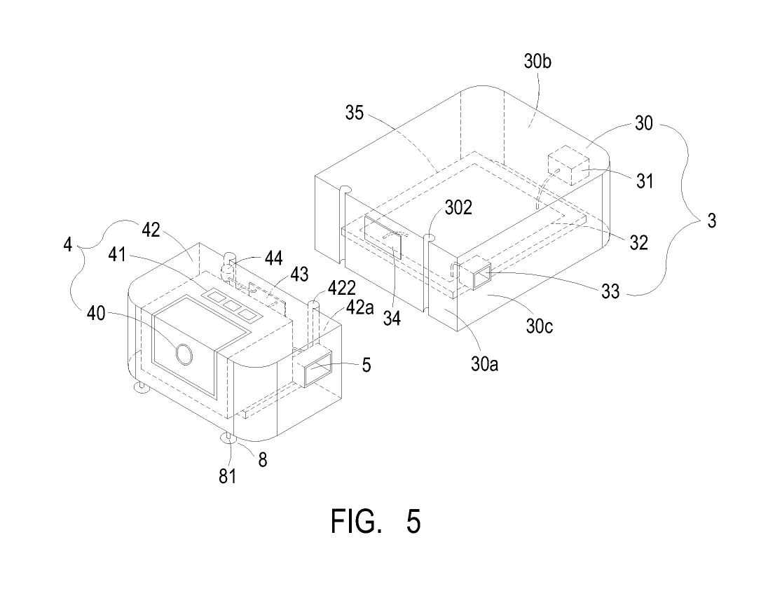

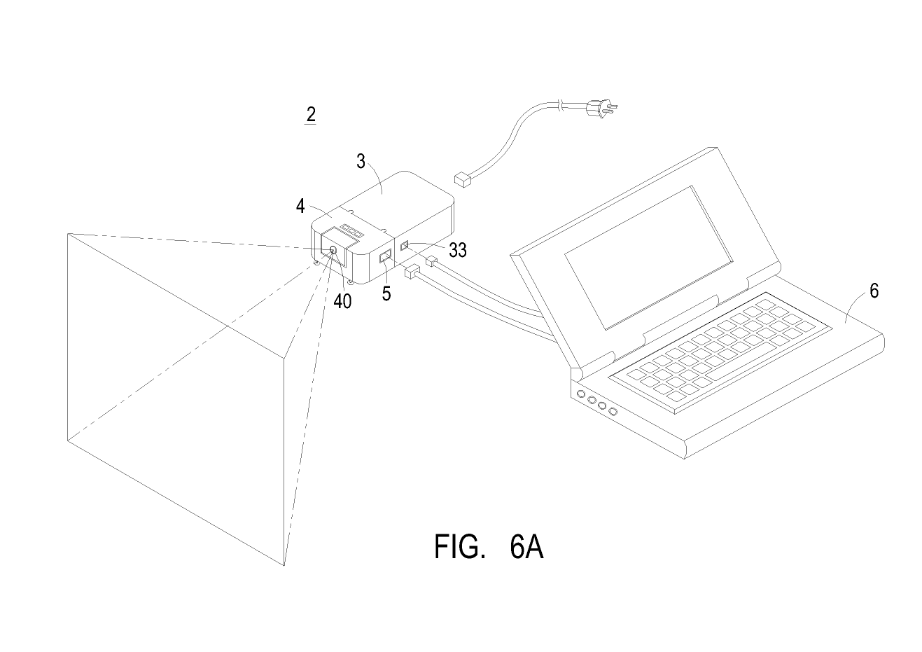

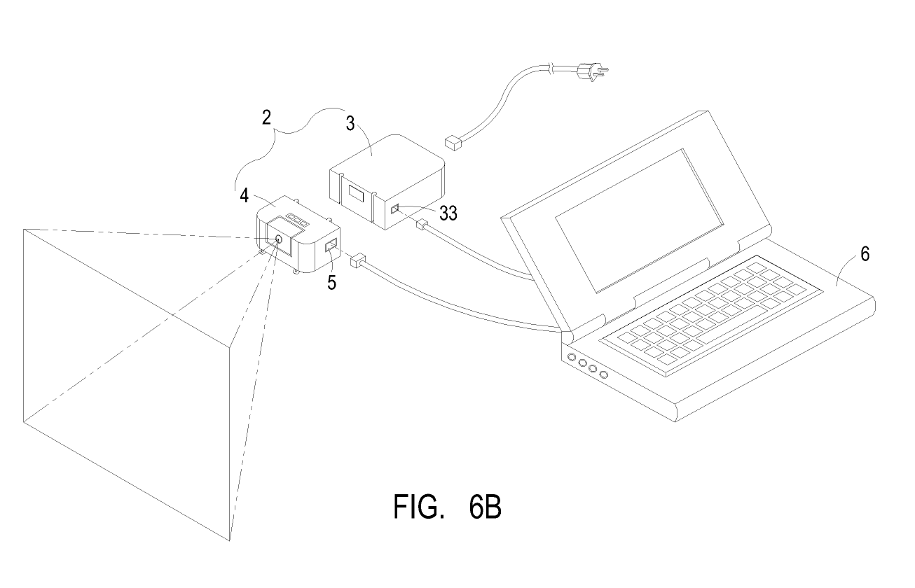

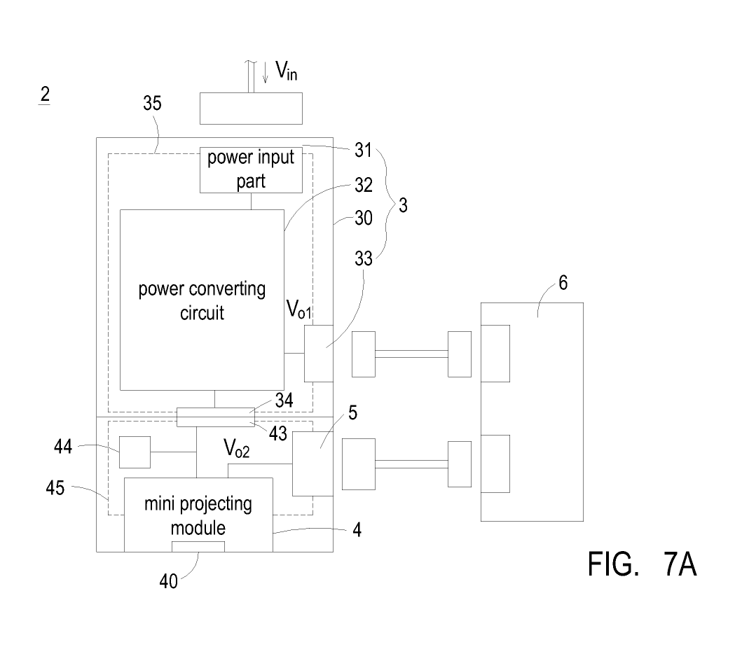

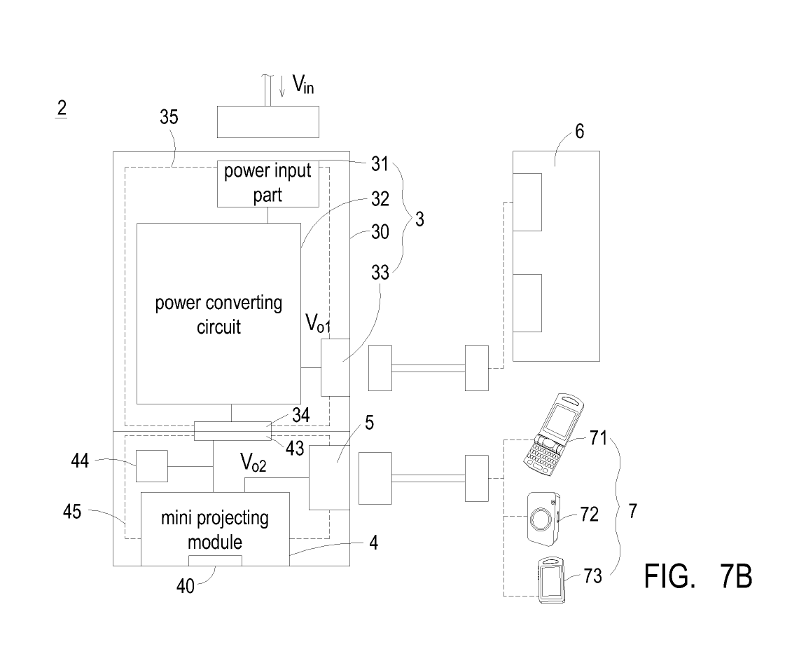

FIG. 5 is a schematic view illustrating a power supply device with a projecting function according to another embodiment of the present invention. FIGS. 6A and 6B are schematic views illustrating a projecting system according to another embodiment of the present invention. FIG. 7A is a schematic functional block diagram illustrating an exemplary projecting system of FIG. 5. Please refer to FIGS. 5, 6A, 6B and 7A. The power supply device 2 comprises a power converting module 3, a mini projecting module 4 and a signal transmission element 5. The power converting module 3 comprises a casing 30, a power input part 31, a power converting circuit 32, a power output part 33 and a first conducting element 34. The power converting circuit 32 is mounted on a circuit carrier 35 (e.g. a printed circuit board). In this embodiment, the mini projecting module 4 is detachably connected with the power converting module 3. The mini projecting module 4 comprises a projecting lens 40, a housing 42 and a second conducting element 43. The projecting lens 40 is exposed outside the housing 42. The second conducting element 43 is partially exposed outside the housing 42. After the second conducting element 43 of the mini projecting module 4 is connected with the first conducting element 34 of the power converting module 3, the mini projecting module 4 is directly or indirectly connected with a portable electronic device 6 (e.g. an image signal source) through the signal transmission element 5 according to a wired or wireless transmission technology. An example of the portable electronic device 6 is a portable computer. The image signal provided by the portable electronic device 6 is processed by the mini projecting module 4 and then projected onto a projection screen or a wall (not shown).

The power input part 31 of the power converting module 3 is connected with an external power source (e.g. a utility power source) for receiving an input voltage Vin. In addition, the power input part 31 is electrically connected with the power converting circuit 32. By the power converting circuit 32, the input voltage Vin is converted into a first output voltage Vo1 and a second output voltage Vo2. The first output voltage Vo1 is transmitted to the portable electronic device 6 through the power output part 33 (e.g. an electric connector, a power cable or a combination thereof). The power converting circuit 32 is also electrically connected with the mini projecting module 4 through the first conducting element 34 and the second conducting element 43. As such, the second output voltage Vo2 is transmitted to the mini projecting module 4 through the first conducting element 34 and the second conducting element 43. In other words, the first output voltage Vo1 and the second output voltage Vo2 are respectively transmitted to the electronic device 6 and the mini projecting module 4. An example of the portable electronic device 6 includes a portable computer. The power converting module 3 is a power converter or a power adapter.

In some embodiments, another electronic device 7 provides the image signal to the mini projecting module 4. As shown in FIG. 7B, an example of the electronic device 7 includes but is not limited to a portable communication device 71, a digital camera 72, a multimedia player (e.g. MP4 player) 73.

In this embodiment, the mini projecting module 4 is detachably connected with the power converting module 3. The casing 30 of the power converting module 3 has one or more first fixing parts 302 (e.g. fastening slots). For example, the first fixing parts 302 are formed in the first surface 30a of the casing 30. Corresponding to the first fixing parts 302, the housing 42 of the mini projecting module 4 has one or more second fixing parts 422 (e.g. protruding blocks). The second fixing parts 422 are formed in the first surface 42a of the housing 42 and engaged with the first fixing parts 302. Due to the engagement between the first fixing parts 302 and the second fixing parts 422, the power converting module 3 and the mini projecting module 4 are combined together. As such, the second output voltage Vo2 could be transmitted to the mini projecting module 4 through the first conducting element 34 and the second conducting element 43.

In this embodiment, the mini projecting module 4 further comprises a chargeable energy storage unit 44 (e.g. a chargeable battery). Once the mini projecting module 4 is detached from the power converting module 3, the chargeable energy storage unit 44 provides electricity for powering the mini projecting module 4. Meanwhile, the portable electronic device 6 is connected with the mini projecting module 4 through the signal transmission element 5. As such, the image signal provided by the portable electronic device 6 is processed by the mini projecting module 4 and then projected onto a projection screen (see FIG. 6B). In some embodiments, when the mini projecting module 4 is connected with the power converting module 3, electricity is transmitted from the power converting module 3 to the mini projecting module 4 while charging the chargeable energy storage unit 44.

In some embodiments, in addition to the projecting lens 40, the mini projecting module 4 further comprises a light source (not shown) and an image-processing unit (not shown). An example of the light source includes but is not limited to a LED light-emitting element or a laser light-emitting element. Moreover, an operating interface 41 is disposed on a fourth surface 30d of the casing 30. Via the operating interface 41, the dimension, brightness, focal length, angle or resolution of the image signal shown on the projection screen could be adjusted. Alternatively, the dimension, brightness, focal length, angle or resolution of the image signal shown on the projection screen could be adjusted according to an IR remote control technology. In some embodiments, the mini projecting module 4 further comprises a circuit board 45. The circuit board 45 is electrically connected to the circuit carrier 35. The light source and the image processing unit could be integrated into the circuit board 45.

The power input part 31 of the power converting module 3 is disposed in the second surface 30b of the casing 30. The power input part 31 is electrically connected between an external power source and the power converting circuit 32 for receiving the input voltage Vin from the external power source, and transmitting the input voltage Vin to the power converting circuit 32. The power input part 31 is for example an electric connector, a power cable or a combination thereof. The power converting circuit 32 is mounted on the circuit carrier 35. In this embodiment, the power converting circuit 32 is an AC/DC converter for converting the input voltage Vin (e.g. an AC voltage) into the first output voltage Vo1 (e.g. a DC voltage) and the second output voltage Vo2 (e.g. a DC voltage). The power output part 33 is disposed in a third surface 30c of the casing 30, and electrically connected to the power converting circuit 32. As such, the first output voltage Vo1 could be transmitted to the portable electronic device 6 through the power output part 33. The power output part 33 is for example an electric connector, a power cable or a combination thereof. The second output voltage Vo2 is transmitted from the power converting circuit 32 to the mini projecting module 4 through the first conducting element 34 and the second conducting element 43. The magnitudes of the first output voltage Vo1 and the second output voltage Vo2 are identical or different. The signal transmission element 5 is disposed in the third surface 30c of the casing 30 for directly or indirectly connecting the mini projecting module 4 with the portable electronic device 6. As such, the image signal provided by the portable electronic device 6 is processed by the mini projecting module 4 and then projected onto the projection screen. An example of the signal transmission element 5 includes but is not limited to an electric connector, a signal connecting cable or a combination thereof. The signal connecting cable is an analog signal connecting cable, a digital signal connecting cable, an optical cable (e.g. an optical fiber cable), or the like. In some embodiments, the signal transmission element 5 is a wireless transmission module (e.g. a Bluetooth module).

In some embodiments, the power supply device 2 further comprises plural height-adjusting elements 8 (see FIG. 5). The height-adjusting elements 8 are disposed on the bottom surface of the housing 40 and arranged in the vicinity of the corners of the bottom surface of the housing 40. By means of the height-adjusting elements 8, the height of the power supply device 2 is changeable, and thus the projecting zone is vertically adjusted according to the practical requirements. An example of the height-adjusting element 8 includes but is not limited to a storable stand, a foldable stand or a rotatable element. In some embodiments, the height-adjusting element 8 has a cushion or a sucker 81 for facilitating fixing the power supply device 2 on a working plane and preventing from abrading the working plane.

In some embodiments, a power cable and a signal connecting cable may be sheathed by a covering body (not shown) so as to form an integrated transmission cable. Alternatively, the power cable and the signal connecting cable are separated from each other but combined together via a fixing element.

In some embodiments, the power output part 33 and the signal transmission element 5 are conductive pads. As such, the power supply device 2 could be directly attached on the main body of the portable electronic device 6 without the power cable and the signal connecting cable. That is, the electricity transmission and the image signal transmission between the power supply device 2 and the portable electronic device 6 are achievable through the conductive pads.

In some embodiments, the projecting lens 40 of the mini projecting module 4 is implemented by an optical transmission line (not shown). The optical transmission line could be extended to a far site and provide multi-directional and multi-angular projecting effects. In this situation, the image processing unit could be optionally installed within the portable electronic device 6, and the image signal is transmitted to the power supply device 2 through an optical transmission line and projected by the projecting lens 40.

In a case that the input voltage Vin fails to be transmitted to the power supply device 2 through the power input part 31, the electricity stored in the battery of the portable electronic device 6 could be reversely transmitted to the power supply device 2 through the power output part 33, and then directly transmitted to the mini projecting module 4 or indirectly transmitted to the mini projecting module 4 through the power converting circuit 32.

In some embodiments, the power converting circuit 32 comprises a first-stage power converting unit and a second-stage power converting unit (not shown). The first-stage power converting unit is an AC/DC converter, and the second-stage power converting unit is a DC/DC converter. The input voltage Vin is converted into the first output voltage Vo1 by the first-stage power converting unit; and the input voltage Vin is converted into the second output voltage Vo2 by the first-stage power converting unit and the second-stage power converting unit. Alternatively, the input voltage Vin is converted into the second output voltage Vo2 by the first-stage power converting unit; and the input voltage Vin is converted into the first output voltage Vo1 by the first-stage power converting unit and the second-stage power converting unit.

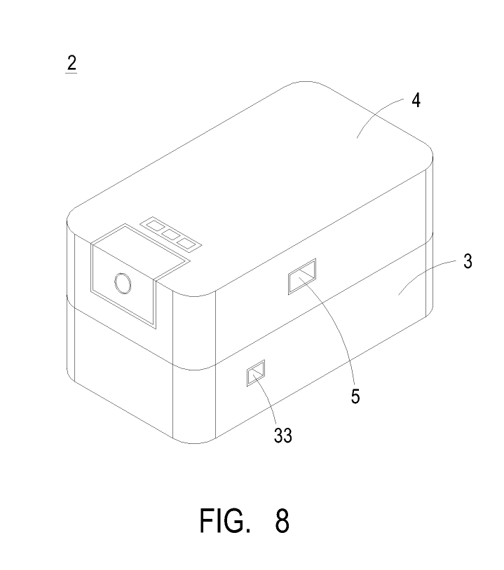

FIG. 8 is a schematic view illustrating a power supply device with a projecting function according to a further embodiment of the present invention. As shown in FIG. 8, the mini projecting module 4 is disposed on the power converting module 3 and electrically connected with the mini projecting module 4. The operating principles of the power supply device shown in FIG. 8 are similar to those illustrated in the above embodiments, and are not redundantly described herein.

From the above description, the power supply device having a projecting function according to the present invention includes a power converting module and a mini projecting module. The mini projecting module is installed within the power converting module. The image signal provided by an image signal source is processed by the mini projecting module and then projected onto a projection screen or a wall. The power supply device of the present invention is advantageous because it has small size, light weightiness and easy portability. In addition, the projecting lens is adjustable to result in a desired projecting angle. Since the power converting module can provide electricity to the mini projecting module and an external electronic device, the applications of the power supply device of the present invention are expanded. Moreover, the power converting module and the mini projecting module may be combined together or detached from each other according to the practical requirements. In this situation, the mini projecting module further comprises a chargeable energy storage unit. Once the mini projecting module is detached from the power converting module, the chargeable energy storage unit provides electricity for powering the mini projecting module. Whereas, once the mini projecting module is connected with the power converting module, the electricity is transmitted from the power converting module to the mini projecting module while charging the chargeable energy storage unit.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply device with a projecting function, said power supply device comprising:
a mini projecting module including a projecting lens for projecting an image;
a power converting module comprising:
a power input part for receiving an input voltage;
a power converting circuit electrically connected with said power input part for converting said input voltage into a first output voltage and a second output voltage, wherein said first output voltage and said second output voltage are respectively transmitted to an electronic device and said mini projecting module; and
a power output part electrically connected with said power converting circuit, wherein said first output voltage is transmitted from said power converting circuit to said electronic device through said power output part; and
a signal transmission element for connecting said electronic device or an image signal source with said mini projecting module so that an image signal provided by said electronic device or said image signal source is transmitted to said mini projecting module through said signal transmission element.

2. The power supply device according to claim 1, wherein said power converting module further comprises a casing, wherein said mini projecting module is disposed within said casing, and said projecting lens is exposed outside said casing.

3. The power supply device according to claim 2, wherein said power converting circuit is an AC/DC converter, said input voltage is an AC voltage, and said first output voltage and said second output voltage are DC voltages.

4. The power supply device according to claim 1, wherein said signal transmission element is an electric connector, a signal connecting cable or a wireless transmission module.

5. The power supply device according to claim 1, wherein said power input part and said signal transmission element are respectively a power cable and a signal connecting cable, which are included in an integrated transmission cable.

6. The power supply device according to claim 1, wherein said power converting module further comprises a circuit carrier, and said mini projecting module further comprises a light source, an image processing unit and a circuit board, wherein said circuit carrier and said circuit board are electrically connected with each other through a wire, said power converting circuit is mounted on said circuit carrier, and said light source and said image processing unit are mounted on said circuit board.

7. The power supply device according to claim 1, wherein said mini projecting module is detachably connected with said power converting module.

8. The power supply device according to claim 7, wherein said power converting module comprises a casing, a first conducting element and a first fixing part, and said mini projecting module comprises a housing, a second conducting element and a second fixing part, wherein after said first fixing part and said second fixing part are engaged with each other, said mini projecting module and said power converting module are combined together so that said second output voltage is transmitted to said mini projecting module through said first conducting element and said second conducting element.

9. The power supply device according to claim 8, wherein said mini projecting module further comprises a chargeable energy storage unit, which is electrically connected to said second conducting element for storing electric energy and providing electricity to power said mini projecting module.

10. The power supply device according to claim 8, wherein if said input voltage fails to be transmitted to said power supply device through said power input part, the electricity stored in a battery of said portable electronic device is reversely transmitted to said power supply device through said power output part, and then transmitted to said mini projecting module.

11. A power supply device with a projecting function, said power supply device comprising:
a mini projecting module including a projecting lens for projecting an image;
a power converting module comprising:
a power input part for receiving an input voltage; and
a power converting circuit electrically connected with said power input part for converting said input voltage;
a signal transmission element for connecting an image signal source with said mini projecting module so that an image signal provided by said image signal source is transmitted to said mini projecting module through said signal transmission element,
wherein said power converting module provides electricity required for powering said mini projecting module and an external electronic device.

12. A projecting system comprising:
an electronic device; and
a power supply device with a projecting function, said power supply device comprising:
a mini projecting module including a projecting lens for projecting an image;
a power converting module comprising a power input part for receiving an input voltage, and a power converting circuit electrically connected with said power input part for converting said input voltage; and
a signal transmission element for connecting said electronic device or an image signal source with said mini projecting module so that an image signal provided by said electronic device or said image signal source is transmitted to said mini projecting module through said signal transmission element,
wherein said power converting module provides electricity required for powering said mini projecting module and said electronic device.
